(19) United States
(12) Patent Application Publication
(10) Pub. No.: US 2008/0307010 A1
(43) Pub. Date: Dec. 11, 2008

(54) Method and System for Sending Changes in Information to a Central System

(75) Inventors: Shelby Cullison, Poway, CA (US); John Moore, Spring Valley, CA (US); Christopher Cummins, Escondido, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated, Kenosha, WI (US)

(21) Appl. No.: 11/758,563

(22) Filed: Jun. 5, 2007

(51) Int. Cl. G06F 17/30

(52) U.S. Cl. 707/201; 707/E17.007

(57) ABSTRACT

A method and system is disclosed for sending changes in information to a central system. The method includes providing a first database having a plurality of information tables for storing information and providing a second database for tracking changes to the information in the information tables of the first database. The second database may include a link table containing links corresponding to the information tables in the first database. The changes in the information tables may be periodically extracted from the first database by using the second database. The changes may be extracted via a link of the link table which corresponds to the information table where an information change occurred. The extracted changes may be sent to a central server.

### FIELD

This description relates generally to information databases, and more particularly, relates to a method and system for tracking changes in information and sending the changes in the information to a central system.

### BACKGROUND

Individual automotive repair shops may collect vehicle information and maintain extensive databases of the vehicle information. For example, individual repair shops may maintain vehicle information for each vehicle the repair shop serves. This vehicle information may take a variety of forms. For instance, vehicle information may include vehicle service information, such as repair orders, vehicle repairs performed, labor performed during repair, and parts used during repair. Further, the vehicle information may include customer information, such as personal information and address information of the owner of the vehicle brought in to the repair shop for service.

In order to maintain extensive databases of vehicle information, automotive repair shops may use a program or system to enter and maintain the vehicle information obtained at the repair shop. The program or system may allow the automotive repair shop to maintain its own individual database of vehicle information. Multiple automotive repair shops may use the same program or system to maintain vehicle information. For instance, multiple repair shops may use a system such as the Mitchell1/Snap-on Shop Management System in order to maintain a database of the vehicle information obtained at the individual repair shop. Each shop may maintain a separate vehicle information database using the shop management system.

It may be beneficial to aggregate each shop's individual database of vehicle information in order to form a comprehensive central database that contains all of the vehicle information from each individual automotive repair shop. Generally, in order to aggregate the vehicle repair operation obtained at the individual shop level, each individual repair shop must send its entire individual vehicle information database to a central server.

### SUMMARY

A method and system is disclosed for sending changes in information to a central system.

According to one embodiment, the method for sending changes in information, such as vehicle information, includes providing a first database and a second database. The first database may be a shop database, such as an individual automotive repair shop's database containing vehicle information. The second database may be a delta database which is designed for tracking any changes made to the first database. The first database may include a plurality of information tables. The second database may include a link table containing at least one link to at least one information table of the first database.

The method includes receiving changes in information in at least one information table of the first database. Upon a change in information in an information table, the method includes tracking, in the second database, at least one change in the information received in at least one information table of the first database. The method further includes extracting the changes via a link of the link table corresponding to the information table or tables where the change occurred. After extracting the changes, the method further includes sending the changes to a central server.

In another embodiment, a system is disclosed for performing the method for sending changes in information to a central system. The system includes a processor, data storage, and machine language instructions stored in the data storage executable by the processor to send changes in information to a central system. The data storage may include a first database having a plurality of information tables. Data storage may also include a second database having a link table, which contains links to the information tables of the first database. The machine language instructions executable by the processor are capable of receiving changes in information in at least one information table of the first database. The change may be an addition, deletion, or modification of information in an information table. The machine language instructions are capable of tracking at least one change in the second database. The machine language instructions are further capable of extracting the changes via a link in the link table corresponding to the changes to the at least one information table. Further, the machine language instructions are further executable to send the changes to a central system.

These as well as other aspects and advantages will become apparent to those of ordinary skill in the art by reading the following detailed description, with reference where appropriate to the accompanying drawings. Further, it is understood that this summary is merely an example and is not intended to limit any of the claims.

### BRIEF DESCRIPTION OF THE DRAWINGS

FIG. 1 is a block diagram of a system in which an embodiment of the system and method of the disclosure can be employed;

FIG. 2 is a block diagram of a system that can be used by a shop in the arrangement of FIG. 1;

FIG. 3 is a detailed block diagram of an aspect of the system of FIG. 2; and

FIG. 4 is a flow chart depicting a method of sending changes in vehicle information to a central system.

### DETAILED DESCRIPTION

As indicated above, this disclosure provides a method and system for sending changes in vehicle information to a central system. While an embodiment is described herein in the context of automotive repair shops that collect vehicle information, the methods and system are broadly applicable to any situation where it may be beneficial to collect changes in information at various distributed locations or databases and send that information to a central system.

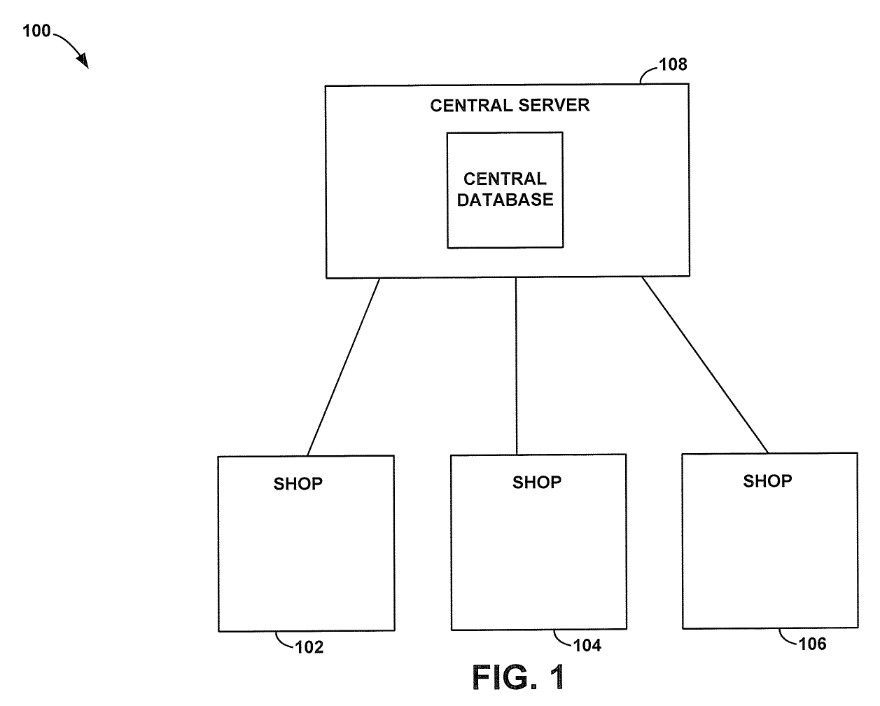

FIG. 1 shows a system 100 in which an embodiment of the system and method of the disclosure can be employed. Note that this and other arrangements and processes described herein are set forth for purposes of example only, and other arrangements and elements (e.g., machines, interfaces, functions, orders of elements, etc.) can be added or used instead and some elements may be omitted altogether.

System 100 includes shops 102, 104, 106 and a central server 108. Shops 102, 104, 106 may be, for example, automotive repair shops. Further, shops 102, 104, 106 may be distributed throughout geographically different locations. For instance, the shops may be automotive repair shops located in different parts of a town or city. Additionally or alternatively, the shops may be automotive repair shops located in different states. The shops could be independent repair shops. They could also be shops that are owned or serviced by a common organization, such as service shops for a fleet of aircraft owned by an airline, or service shops of the United States military where service and repair is conducted for military equipment such as helicopters, light armored vehicles, jet fighters, or ships.

Each shop may obtain vehicle information throughout the day to day operations of the shop. For the purposes of this disclosure, vehicle information is intended to include any information that an automotive repair shop may obtain throughout its operations or may collect and store in a database of information. Such vehicle information may take a variety of forms. For instance, the information may be information relating to the vehicles serviced, such as year, make, model, engine type, and body type of the vehicles serviced. The vehicle information may also be customer information such as personal information of the owner of the vehicle being serviced. The vehicle information may be vehicle repair operations information. For instance, the information may be repair order information, information on labor performed during repair, and information on parts used during repair. The vehicle information may also be any other information relating to a vehicle that a repair shop may obtain relating to a vehicle.

Each shop may maintain a shop database of vehicle information. Each shop may use a shop management system in order to collect and save the vehicle information the shop obtains in its day to day operations. For instance, shops 102, 104, 106 may use the Mitchell1/Snap-on Shop Management System in order to collect and save any or all vehicle information the shop obtains. This specific shop management system is merely an example, and other shop management applications used to store vehicle information data are possible as well.

Each shop may maintain a separate database of vehicle information using its shop management system. Gathering the information from individual shops and transferring the information to a central database may be beneficial. Aggregating database information obtained at shops 102, 104, 106 in central database 116 may be beneficial for a variety of reasons. The aggregated data may be analyzed for trends in the automotive industry. For instance, analysis of the aggregated data may reveal that a vehicle of a certain make and model generally develops an issue with its front axles at a certain amount of miles. This information may be useful for repair shops servicing such vehicles.

Rather than periodically sending into a central database a shop's entire database record, it may be beneficial for individual shops to send in only changes in the database information. Each shop may use the method and system described below in order to send any changes in its database of vehicle information to central server 108.

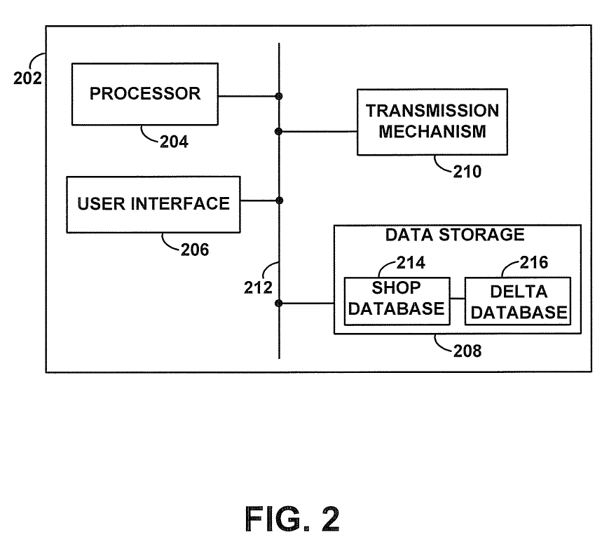

FIG. 2 shows a detailed block diagram of a system 202 that a shop, such as shop 102, 104, or 106, may use in order to collect vehicle information and send changes in vehicle information to central server 108. As shown in FIG. 2, system 202 may include a processor 204, a user interface 206, data storage 208, and a transmission mechanism 210, all of which may be coupled together by a system bus or other mechanism 212. Each of these components may take various forms.

For example, processor 204 may comprise one or more general purpose processors (e.g., INTEL microprocessors) and/or one or more special purpose processors (e.g., digital signal processors). Further, processor 204 may execute computer-readable program instructions, such as the program instructions described in this description.

In an embodiment, data storage holds a set of logic (e.g., computer instructions) executable by processor 204 to carry out the various functions described herein. Alternatively, the logic may be embodied in firmware and/or hardware. Data storage 208 may comprise a computer readable medium. A computer readable medium may comprise volatile and/or non-volatile storage components, such as optical, magnetic, organic or other memory or disc storage, which can be integrated in whole or in part with a processor, such as processor 204. Alternatively, the entire computer readable medium may be remote from processor 204 and coupled to processor 204 by a connection mechanism, such as mechanism 212, and/or a network cable.

As shown in FIG. 2, data storage 208 may also hold a shop database 214 and a delta database 216. While shop database 214 and delta database 216 are depicted in the same data storage 208 device, it should be understood that the shop database and delta database may be in distributed data storage devices. Shop database 214 may be the database storing the vehicle information obtained by the individual repair shop. Delta database 216 is a database that may operate to track any changes made to the shop database 214. System 202 may use delta database 216 in order to extract the tracked changes from shop database 214. System 202 may then send the extracted changes to a central server or database.

A worker at an automotive repair shop, such as a technician or shop management personnel, may use the user interface 206 of system 202 in order to enter vehicle information into the shop database 214. User interface 206 may, for example, include a keyboard. A worker may make multiple changes to the shop database throughout the normal operations of the automotive repair shop. When a change is made to shop database 214, system 202 may be operable to track the change in delta database 216. The logic (e.g., computer instructions) executable by processor 204 may cause system 202 to update delta database 216 to include information indicating that a change has been made to shop database 214.

Further, system 202 may be operable to extract the changes from shop database 214 send these changes to a central server. System 202 may extract the changes from shop database 214 and send the changes to a central server on a periodic basis. The logic executable by processor 204 may cause system 202 to extract the changes from the shop database. System 202 may then send the changes to a central server using transmission mechanism 210. System 202 may, for instance, send the information to the central server wirelessly. A data link, such as Ethernet, may connect system 202 to a central server, such as central server 108. Transmission mechanism 210 may comprise a network interface card for connecting to the data link.

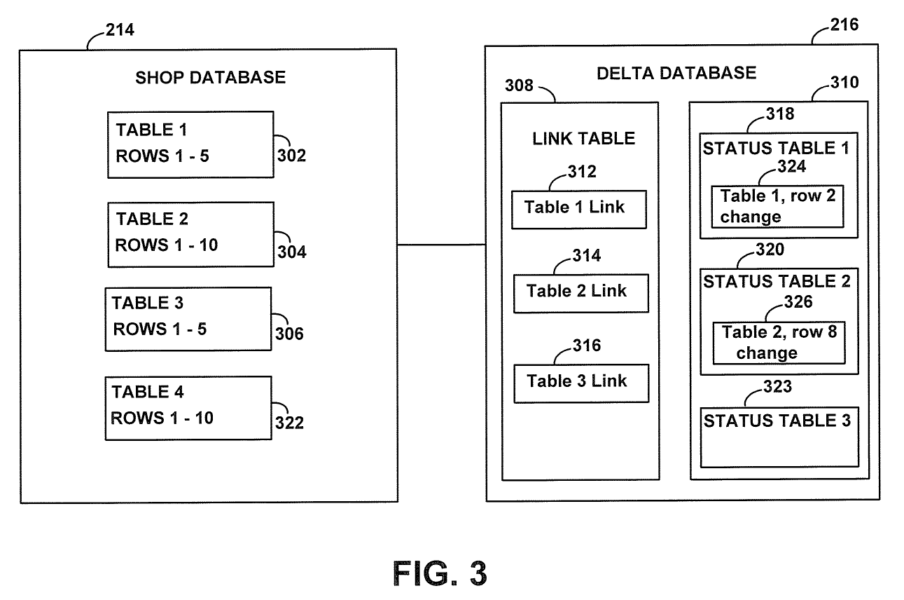

FIG. 3 describes the contents of shop database 214 and delta database 216 and how the databases may operate in conjunction with each other in order to track changes in shop database 214.

Shop database 214 may contain a plurality of information tables, such as information tables 302, 304, 306, and 322. Alternatively, shop database 214 may be a non-table database and, rather than containing information tables, may contain information sections. For example, shop database may be a hierarchical database, an XML, database, or a Conference on Data Systems Languages (CODASYL) database. Such databases may contain a plurality of information sections, rather than information tables. Other types of databases are possible as well.

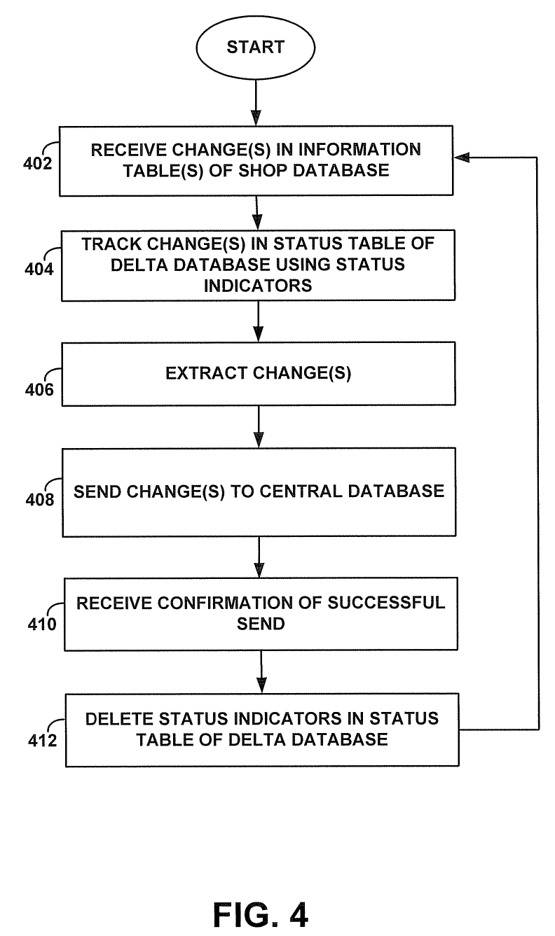

Returning to FIG. 4, while only four information tables are shown, it should be understood that shop database may contain a greater or fewer number of information tables. Information tables may be tables for a variety of different types of information. In the context of automotive repair shops, there may be an information tables for vehicle information, vehicle repair history, number of miles driven, customer information, shop inventory information, repair orders, parts used in repairs, parts ordered, labor performed during service, trouble codes, and diagnostic procedures and information. Further, in this context of automotive repair shops, it should be understood that there may be an information table for any type of vehicle information an automotive repair shop may desire to track.

Further, each information table may be divided into separate sections. For instance, an information table may include a plurality of fields. As shown in FIG. 3, the information tables may have different amounts of fields. For example, information tables 302 and 306 are shown to each have five fields (rows 1-5), while information tables 304 and 322 are shown to have ten fields (rows 1-10).

Each field in a particular information table may be associated with a unique primary key. A primary key is a unique identifier for a field in an information table. For example, each field in information table 302 may have a primary key associated with it. For instance, the primary key for row 1 may be “1”, the primary key for row 2 may be “2”, and so forth.

Delta database 216 may contain a link table 308 and a collection 310 of status tables 318, 320, and 323. Link table 308 may contain information table links 312, 314, and 316. Information table link 312 may be a link to table 302 of the shop database. Similarly, information table link 314 may be a link to information table 304 of the shop database and information table link 316 may be a link to information table 306 of the shop database. As is known in the art, one database may access information in another database via links in a link table. Links may operate to make sections of a database, such as tables, appear as if they are in the database containing the links when they are really in another database. System 202 may use link technology, such as the link technology used in Microsoft access, to implement the link tables. However, this is merely an example of link technology, and other link technology is possible as well. Therefore, while delta database 214 does not contain the information of shop database 214, delta database 216 has access to the information in the information tables of shop database 214.

Delta database 216 may be configured to track changes in only certain information tables of shop database 214. In the context of the automotive industry, it may be beneficial to track changes in information so that one may obtain a central database of information. However, depending on what trends one is attempting to discover, only certain types of information may need to be included in the database. Therefore, it is not necessary to update the central database to include all of the information changes to each information table in shop database 214.

Thus, delta database 216 does not necessarily need a link and/or status table for each information table in the shop database. For example, in FIG. 3, delta database 216 is configured to track changes to information tables 302, 304, and 306. The database includes links to those information tables and status tables as well. However, delta database does not contain a link for information table 322 or a status table for information table 322. It should be understood, however, that if one desired to track changes in information table 322, delta database 216 could be altered to track the changes. Generally, the number of status tables in delta database 216 will correspond to the number of links in the link table of delta database 216.

FIG. 4 illustrates a method of sending changes in vehicle information to a central server in accordance with an embodiment of the disclosure. The example of FIG. 4 shows functions performed by a shop application, such as system 202, operating in accordance with an embodiment of the disclosure. One or more of these functions shown in FIG. 4 may be omitted. Further, the discussion below refers to information tables. As explained above, system 202 may maintain information in information sections rather than tables. Therefore, it should be understood that the discussion below could also refer to information sections.

At step 402, system 202 may receive changes in the information tables of shop database 214. As explained above, a worker at an automotive repair shop may use system 202 to enter changes in vehicle information into shop database 214. When the worker enters information into the system, machine language instructions in data storage and executable by the processor may write the changes to the shop database. Changes in vehicle information may include information being added, modified, or deleted from shop database 214. As described above, changes may be made to the information tables 302, 304, 306, 322 of shop database 214. In particular, changes may be made to fields of the information tables. Information in the fields may be changed by being added, modified, or deleted.

In addition, system 202 may receive changes in the information tables of shop database 214 from a vehicle service tool that is in communication with system 202. A vehicle service tool may be a data collection mechanism that will typically but not necessarily take the form of a diagnostic device. The data collection mechanism may obtain data from a repair session (e.g., fault codes, wear readings, resistance readings, exhaust gas readings, etc.). The data may be collected entirely automatically by the data collection mechanism or could have a user interface to accept data measured or collected by a technician. The vehicle service tool may be operable to automatically enter data into system 202.

As an example of changes information, such as a change entered by a technician or a vehicle service tool, we can assume that the information in Table 1, Row 2 was modified and that information was added to Table 2, Row 8. System 202 may write these changes to the shop database.

At step 404, system 202 may track the changes in the information tables in delta database 216. In addition to the machine language instructions being operable to write the information changes to the shop database, machine language instructions may be operable to add information to the delta database 216 upon a change in the data. For instance, the library may add status indicators to the status tables of delta database 216 that indicate the changes made.

Continuing the example of the two changes discussed above, since a change was made to Table 1, Row 2, system 202 may add a status indicator 324 to status table 318. The status indicator 324 may be associated with the unique primary key for Table 1, Row 2. As mentioned above, this primary key may be, for example, “2”. Further, the status indicator 324 may indicate that the information has been modified.

Further, since information was added to Table 2, Row 8, system 202 may add a status indicator 326 to status table 320. The status indicator may be associated with the unique primary key for Table 2, Row 8. Further, the status indicator may indicate that the information has been added to Table 2, Row 8.

As explained above, delta database 216 may be designed to track changes in only certain information tables of shop database 214. For instance, changes may be made to information table 322 of shop database 214. However, in the example of FIG. 3, delta database 216 is not configured to track the changes to information table 322.

At step 406, system 202 may extract the changes in the information tables of the shop database via the links in delta database 216. In order to extract the changes in the information tables, system 202 may refer to the status tables of the delta database 216. For each status indicator, system 202 may access the changed information through the proper link in link table 308. For example, for status indicator 324, system 202 may access the information in Table 1, Row 2 using link 312. For status indicator 326, system 202 may access the information in Table 2, Row 8 using link 314.

At step 408, system 202 may send the extracted changes to central server 108. System 202 may send the extracted changes to central server 108 in various ways. For example, system 202 may send the information through a wireless network, or, alternatively, through a wired network. Additionally, the form system 202 sends the extracted information in may vary. System 202 may be programmed to form a markup language data file including the extracted changes. For instance, the data file may be an extensible markup language (XML) data file. Alternatively, the data file may be a Hypertext Markup Language (HTML) data file or a Wireless Markup Language (WML) data file. Other types of data files are possible as well. System 202 may send this data file to central server 108. Additionally, before sending the data file, system 202 may encrypt the data file.

Further, the system may extract the changes and send the changes to the central server on a periodic basis. For instance, the system may perform these steps on a daily basis. Alternatively, the system could perform these steps multiple times a day, such as every hour. Additionally, shop personnel could “push” the data to the central server by, for example, entering a command to transmit the changes to the central server. Further, the central server could “pull” the data by, for example, sending a request to the shop system, such as system 202, for the shop to send the changes to the central server.

At step 410, the system may receive an indication or a confirmation that the extracted information was successfully sent to the central server. For instance, upon receipt of information, the central server may be programmed to send a confirmation to the system 202.

At step 412, system 202 may delete the status indicators in the status table of delta database 216. For example, system 202 may delete status indicators 324 and 326. Therefore, after an extraction and confirmation that the extracted changes were sent successfully, the status tables of delta database 216 will be empty. Further, as shown in FIG. 4, the method may continue with the process looping back to step 402 and repeating steps 402-412. Therefore, when steps 402-412 are repeated, only new changes in shop database 214 will be tracked in delta database 216. Consequently, when a subsequent extraction is performed, only changes since the last extraction will be tracked and eventually extracted.

When a central server receives changes in vehicle information from a shop, such as shop 102, 104, 106, the central server may integrate the changes into its central database of information.

Insofar as the embodiments described herein may include or be utilized in machines taking the form of vehicles or engines for vehicles, they may include or be utilized with any appropriate voltage or current source, such as a battery, an alternator, a fuel cell, and the like, providing any appropriate current and/or voltage, such as about 12 Volts, about 42 Volts and the like. The embodiments described herein may be used with any desired system or engine. Those systems or engines may comprises items utilizing fossil fuels, such as gasoline, natural gas, propane and the like, electricity, such as that generated by battery, magneto, fuel cell, solar cell and the like, wind and hybrids or combinations thereof. Those systems or engines may be incorporated into other systems, such as an automobile, a truck, a boat or ship, a motorcycle, a generator, an airplane and the like. Furthermore, the disclosure is applicable to repair operations generally and is not limited to any particular field application.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A method for sending changes in information to a central system, the method comprising:
providing a first database and a second database, wherein the first database comprises a plurality of information tables, and wherein the second database comprises a link table containing at least one link corresponding to at least one of the information tables in the first database, wherein one link corresponds to one information table in the first database;
receiving changes in information in at least one information table of the first database;
tracking, in the second database, at least one change in the information received in the at least one information table of the first database;
extracting the at least one change via a link of the link table corresponding to the at least one information table; and
sending the at least one change to a central system.

2. The method of claim 1, wherein the second database further comprises at least one status table, and wherein tracking at least one change in the information comprises adding a status indicator to the at least one status table, wherein the status indicator indicates that an information change has occurred in the first database.

3. The method of claim 2, wherein the plurality of information tables have at least one field, wherein each respective field of an information table is associated with a respective unique primary key, and wherein the status indicator that indicates that an information change has occurred in the first database is associated with the unique primary key for the field of the information table that has been changed in the first database.

4. The method of claim 3, wherein extracting the at least one change from the second database comprises:
for each status indicator associated with a unique primary key for a field of the information table that has been changed in the first database, accessing the field of the information table that has been changed in the first database via the link in the link table of the second database; and
extracting the information from the field of the information table that has been changed.

5. The method of claim 1, wherein extracting the at least one change from the second database and sending the at least one change to a central system is performed on a periodic basis.

6. The method of claim 5, wherein the periodic basis is once a day.

7. The method of claim 5, wherein tracking at least one change in information comprises tracking at least one change in the information since a previous extraction from the second database that was successfully sent to the central system.

8. The method of claim 8, wherein the information is vehicle information.

9. The method of claim 8, wherein tracking, in the second database, at least one change comprises tracking at least one change in at least one specific information table of the first database.

10. The method of claim 9, wherein the at least one specific information table of the first database is an information table for vehicle information selected from the group consisting of vehicle repair history, number of miles driven, trouble codes, and diagnostic procedures.

11. The method of claim 1, further comprising:
forming a markup language data file comprising the extracted at least one change; and
encrypting the markup language data file,
wherein sending the at least one change to the central system comprises sending the encrypted markup language data file to the central system.

12. A method of sending changes in information to a central system, wherein a plurality of entities send changes in information to the central system, wherein each entity carries out the method of claim 1.

13. A method for sending changes in information to a central system, the method comprising:
providing a first database and a second database, wherein the first database comprises a plurality of information sections, wherein the second database comprises a link table containing at least one link corresponding to at least one information section in the first database, wherein one link corresponds to one information section in the first database, and wherein the second database further comprises at least one status table;
receiving changes in information in at least one information section of the first database;
tracking, in the second database, at least one change in the information received in the at least one information section of the first database by adding a status indicator to the at least one status table, wherein the status indicator indicates that an information change has occurred in the first database;
extracting periodically the at least one change via a link of the link table corresponding to the at least one information section; and
sending the at least one change to a central system.

14. The method of claim 13, wherein the information section is an information table.

15. A system for sending changes in information to a central system, the system comprising:
a processor;
data storage, wherein data storage comprises a first database and a second database, wherein the first database comprises information tables, and wherein the second database comprises a link table containing links to the information tables in the first database; and
machine language instructions stored in the data storage executable by the processor to:
(i) receive at least one change in information in at least one information table of a first database,
(ii) track the at least one change in the second database,
(iii) extract the at least one change via a link of the link table corresponding to the at least one information table, and
(iv) send the at least one change to a central system.

16. The system of claim 15, wherein the second database further comprises at least one status table, and wherein the machine language instructions stored in data storage executable by the processor are further executable to add a status indicator to the at least one status table when a change has been made in an information table of the first database.

17. The system of claim 15, wherein the information tables comprise at least one field, and wherein the status indicator is associated with a unique primary key, wherein the unique primary key is associated with a field in the information table.

18. The system of claim 15, wherein the machine language instructions stored in data storage are executable by the processor to extract the at least one change via a link of the link table on a periodic basis.

19. The system of claim 15, wherein the machine language instructions stored in data storage are executable by the process to track at least one change in the information since a previous extraction from the database that was successfully sent to the central system.

20. The system of claim 15, wherein the machine language instructions stored in data storage are operable to:
form a markup language data file comprising the extracted at least one change;
encrypt the markup language data file; and
send the encrypted markup language data file to the central system.
